(19) United States
(12) Patent Application Publication
(10) Pub. No.: US 2007/0001485 A1
(43) Pub. Date: Jan. 4, 2007

(54) Transition of lines to a door leaf

(76) Inventor: Reinhold Jarolim, Weyer (AT)

Correspondence Address: BARNES & THORNBURG LLP, 750-17TH STREET NW, SUITE 900, WASHINGTON, DC, 20006-4675, US

(21) Appl. No.: 10/558,035

(22) PCT Filed: May 27, 2004
(86) PCT No.: PCT/EP04/05690

§ 371 Date: Nov. 22, 2005

(30) Foreign Application Priority Data
Jun. 2, 2003 (AT) A 853/2003
Jan. 30, 2004 (AT) A 129/2004

(51) Int. Cl. B60K 37/00

(52) U.S. Cl. 296/208

(57) ABSTRACT

A routing arrangement for routing one or more of electrical, pneumatic and hydraulic lines from a door leaf of a vehicle to the vehicle. The routing arrangement includes a vehicle having a carriage body, a door on the vehicle having a door leaf, and a drive to operate the door leaf.

### BACKGROUND AND SUMMARY

The present disclosure relates to an arrangement for routing electrical, pneumatic and/or hydraulic lines from a door leaf of a vehicle to the vehicle. In particular, the present disclosure relates to a rail-borne vehicle, an elevator cabin or cable-car cabin, or the like. The door leaf is operated by a drive.

In recent years, vehicle doors, which are to be understood in the present disclosure as rail-borne vehicles, but which also are understood to be the cabins of elevators, cable cars and the like, have become increasingly complicated units. Electrical keys and/or switches for opening the doors are fitted to the door leaves and sensors are fitted in the region of the main closing edge of the door in order to be able to detect whether objects or people are trapped in the door. In addition, illumination devices or illuminated operating instructions are occasionally provided on the door leaf, and the like. In the same way, sensors and switches are increasingly provided on the portal (door frame) in order to monitor whether the door leaf moves correctly into its closed end position. Also, in various cases, door seals are deformed by the application of pressure after the door is closed in such a way that they press in firmly between the portal and the door leaf and seal the door, and the like. In the present disclosure, the term “lines” is to be understood as being cables and/or tubes.

In this context, specific problems are created by the cables being laid between the door controller, which is to be understood quite generally as the overall electronic/pneumatic/hydraulic system or systems which control and monitor operation of the door. The door controller is usually situated in the portal, above the door leaf in contemporary doors, on the one hand, and on the other hand the door controller may be in or part of the door leaf itself, the so-called “routing arrangement”. In this case, it is necessary to remember that the operators of the vehicles require doors which free the entire width of the portal as far as possible when in the open state, and in which no component protrudes beyond the periphery of the portal, its contour with which it is attached to the vehicle. The background or goal is not only the most efficient possible utilization of the space available in the vehicle for the portal, but also the provision of the possibility of inserting the door in one piece, as far as possible with door leaves which are preassembled and adjusted in the portal, into the vehicle and securing it there. In this case, each part of the drive which protrudes beyond the contour of the portal in whatever direction would be extremely obstructive.

The result of all of this is that, in modern vehicle doors, the controller, the drive, the signalling lines and the like are concentrated above the door leaf in the door frame. As a result, the space available in this region is densely populated, and this has a negative effect in terms of maintenance and inspection.

A great deal of the space used in the above-described way is taken up with accommodating the various supply and signalling lines for the door leaf or leaves. The present disclosure relates to a laying of the lines which run between the door leaf and the portal, be they electrical, hydraulic or pneumatic lines, in a simple, reliable, clear and space-saving manner.

The present disclosure provides for a so-called power chain, in which the lines run, starting from a point on the portal close to the secondary closing edge as far as approximately the middle of the door leaf, in the uppermost region of said door leaf.

Such power chains of differing dimensions are known from various fields of application of the art, and they are used in trolleys of cranes and the like, for example.

A feature of such power chains, which are composed of links which are attached to one another, is their ability to bend through 180° in one plane, and in some cases somewhat further, and to be rigid or, in some cases, scarcely bent in the other planes or directions. When the first and the last link of such a chain are correspondingly attached and the two end links are then moved in the intended direction of movement, the point at which the chain curves moves and the chain and the flexible structures, such as cables, tubes or the like, mounted in said chain thus move in an orderly manner.

Other aspects of the present disclosure will become apparent from the following descriptions when considered in conjunction with the accompanying drawings.

### BRIEF DESCRIPTION OF THE DRAWINGS

FIG. 1 shows a view of a swinging/sliding door in its suspension and drive region, as seen in the direction of arrow I in FIG. 3, according to the present disclosure.

FIG. 2 shows a view of the door of FIG. 1, as seen in the direction of arrow II in FIG. 4.

FIG. 3 shows a view in the direction of arrow III in FIG. 1.

FIG. 4 shows a view in the direction of arrow IV in FIG. 2.

FIG. 5 shows a view of another embodiment of a door, the door being in the closed position, according to the present disclosure.

FIG. 6 shows a view of the door of FIG. 5 with the door in the opened position.

FIGS. 7 and 8 show views of a power train of the embodiment of FIGS. 5 and 6.

### DETAILED DESCRIPTION

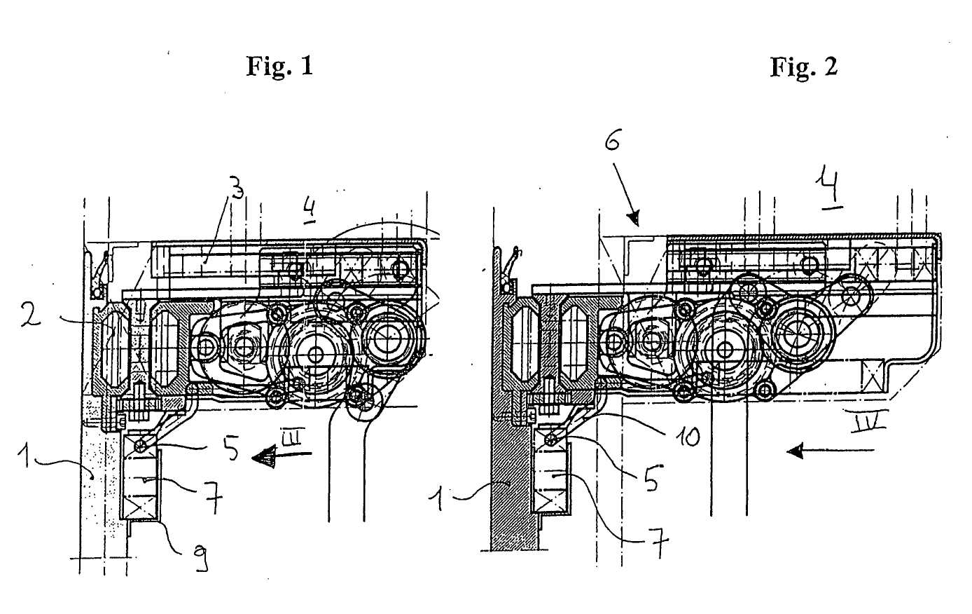

FIG. 1 illustrates an upper region of a swinging/sliding door, which is equipped in accordance with the present disclosure, in the region of a drive 6 of said door in the direction of a swinging movement of the door along an outer wall of a vehicle in a direction of a longitudinal axis of the vehicle. In the embodiment, a suspension arrangement of a door leaf 1 comprises a multipart telescope 2, which in its entirety can be moved along a rail 3 which runs normal to the longitudinal axis of the telescope 2 and is attached to a carriage body 4. The corresponding movement corresponds to an opening-out movement of the door leaf 1, and the movement along the telescope 2 corresponds to an actual opening movement.

Other suspension arrangements and mechanisms are, of course, also feasible.

However, mechanisms of this type may currently share a common feature, in that a whole series of electrical and/or pneumatic and/or hydraulic circuits or lines are, in the widest technical sense, fitted to the door leaf 1. An arrangement of these circuits, or lines, in the door leaf 1 is predefined within limits for ergonomic or technical reasons, and the associated supply and signalling lines in the door leaf 1 itself can also be laid without great problems. What is problematical is routing all of these cables and/or tubes from the moving door leaf 1 to an articulation point 5 which is fixed in position either with respect to the carriage body 4 or with respect to the drive which is denoted as numerical designation 6.

According to the present disclosure, the above-noted problem is addressed by a power chain 7 which is attached to the door leaf 1 close to an upper horizontal edge of said door leaf 1.

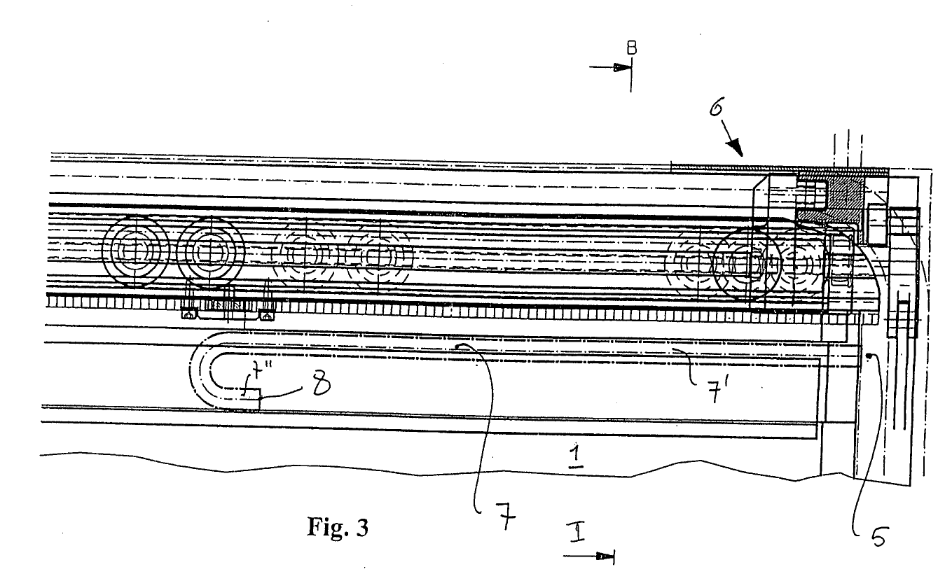

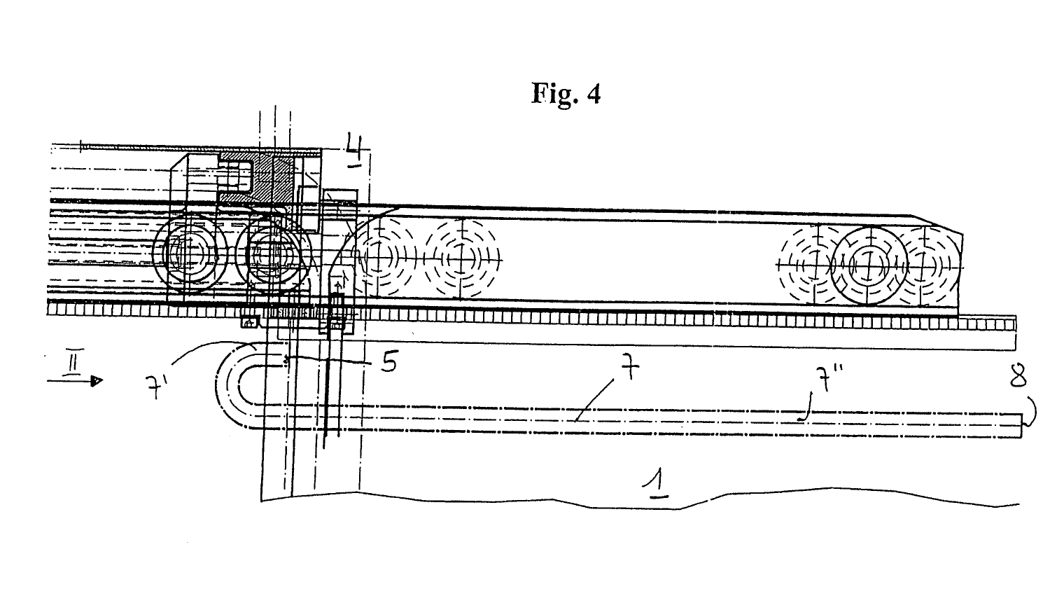

Power chains, such as, for example, power chain 7, may be essentially structures similar to thrust chains which comprise individual segments and are able to curve in one direction but remain rigid in all other directions. The movement of the power chain 7 can be seen in FIGS. 3 and 4. FIG. 3 shows a view in the direction of arrow III in FIG. 1 with the doors in the closed state. A drive-side end or end point 5 of the power chain 7 is attached to a fixed point of the drive 6 and its other end is attached to a fixed point or end point 8 on the door leaf 1. Said power chain 7 runs between these two fixed points in the manner of a cable which is looped around two rollers so as to form an upper strand 7′ and a lower strand 7″ which may be very short in the position of the door leaf 1 shown, for example, in FIG. 3.

If the door is now opened and the door leaf 1 assumes the position illustrated in FIG. 4 in the course of its opening-out movement and subsequent opening movement, the drive-side end 5 also performs the opening-out movement (compare FIGS. 1 and 2). The drive-side end 5 does not perform the actual opening movement. In the course of this opening movement, a curved region of the power chain 7 is moved from one end of this power chain 7 to the other end and has thus made possible a connection between the two end points 5 and 8 which move in relation to one another. The course of the cables and/or tubes which are routed in the power chain 7 is not shown for reasons of clarity, and only the power chain 7 is illustrated.

On account of the inherent rigidity of the power chain 7 with respect to all bends and curves which exceed 180° in the direction shown, it is possible to form the power chain 7 to be unsupported by correspondingly clamping the two end points 5, 8. However, a cover 9 (see FIG. 1) can be provided on the door leaf 1, firstly to provide mechanical support, and secondly to provide protection against inquisitive people and vandals. A cover 9 of this type also means that it is possible to use power chains which can, for example, be bent somewhat more than 180° and permit a certain opposing curve about the same axis (not shown). These power chains may be laid one on top of the other in a stretched region and although they are particularly suitable for long movement paths, they can also be used in the present field of application since they make it more difficult for unauthorized people to gain access by automatically covering an actual channel in which the cables/tubes are located.

In this embodiment, cables/tubes are passed from the carriage body-side end 5 of the power chain 7 to a switching point (electronics system, solenoid valve etc.) via a channel 10 within the drive 6 and subsequently via a short loop or a spiral guide, actually a helical guide, such that a short movement path between the drive 6 and the carriage body 4 is bridged (not shown). This short movement path may be bridged without problems.

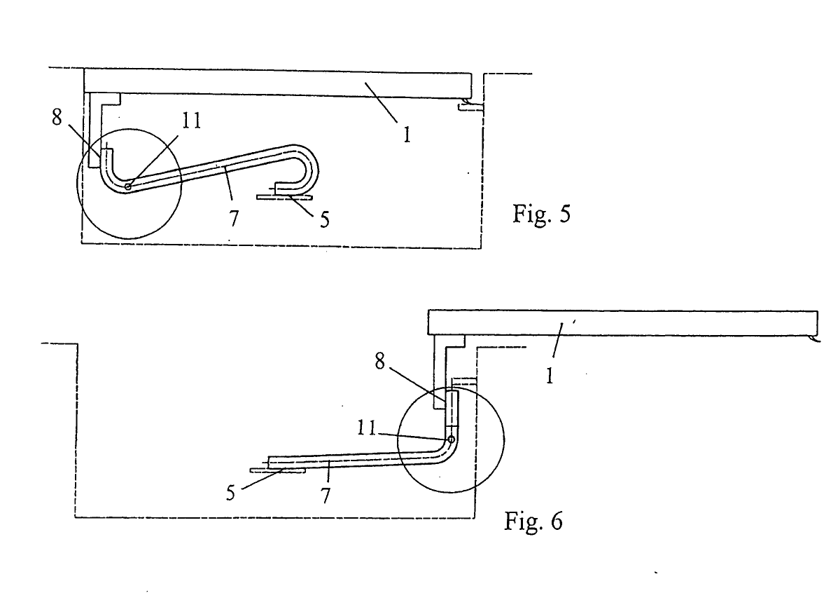

FIGS. 5 and 6 show another embodiment in which the power chain 7 has an S-shaped profile in the closed position of the door and is able to guide cables from a part which is fixed to the carriage body 4 directly to a part which is fixed to the door leaf 1 of swinging/sliding doors. The attachment or end point 8 of the power chain 7 on the door leaf 1 runs approximately normal to a plane of the door leaf 1. It is, of course, also possible to arrange the attachment point 8 at another angle when a power chain 7 of the type shown in FIGS. 5 and 6 is used.

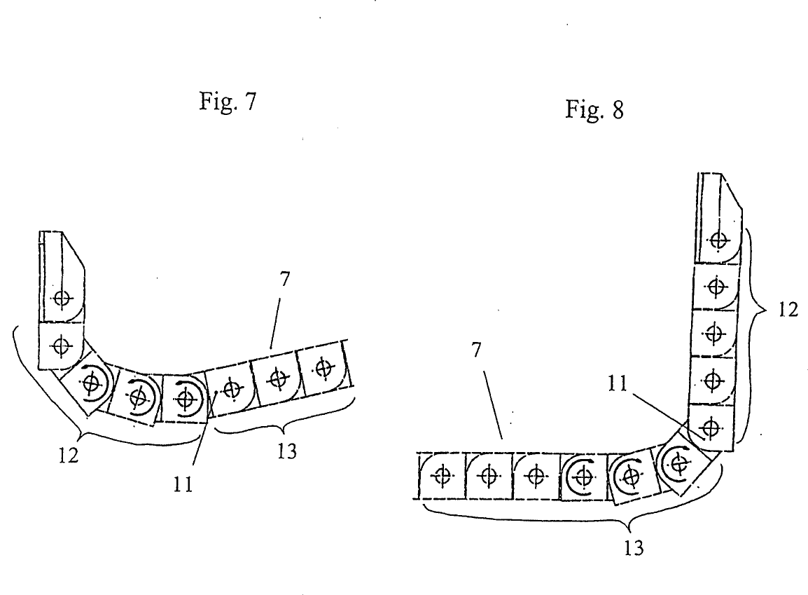

In this embodiment, the power chain 7 is divided into two sections in each of which said chain 7 can rotate in an opposite direction to the other section. Such a design of the power chain 7 is shown in FIGS. 7 and 8. At a point 11 of the power chain 7, the type of individual link changes from a first direction of rotation 12 to the opposite rotation direction 13. As a consequence of the two ends of the power chain 7 being attached, the cables, tubes etc. are able to be routed from attachment point 5 which is fixed to the carriage body 4, to attachment point 8 which is fixed to the door leaf 1 in an orderly and reliable manner, in spite of movement components normal to the plane of the door leaf 1.

The present disclosure can be applied to sliding doors and pocket doors without problems since there is no opening-out movement of the door leaf 1, with the result that the end point 5 may also already be situated on the carriage body 4. In the case of drives of different design for swinging/sliding doors, a solution according to the present disclosure may also be applied since each drive may comprise at least one component which also performs the opening-out movement of the swinging/sliding door and therefore can also be fitted with the end point 5 of the power chain 7.

The present disclosure can also be applied to curved door leaves with curved movement sequences, as are common, for example, in cable-car cabins, since the power chain can also follow such movement sequences.

Although the present disclosure has been described and illustrated in detail, it is to be clearly understood that this is done by way of illustration and example only and is not to be taken by way of limitation. The scope of the present disclosure is to be limited only by the terms of the appended claims.

I claim:

1. A routing arrangement for routing one or more of electrical, pneumatic and hydraulic lines from a door leaf of a vehicle to the vehicle, the routing arrangement comprising:
a vehicle having a carriage body;
a door on the vehicle, the door having a door leaf;
a drive to operate the door leaf;
a power chain having a first end point attached to the door leaf in an upper region of the door leaf parallel to an upper, horizontal door edge, and a second end point attached to one of the drive and the carriage body; and
one or more of electrical, pneumatic and hydraulic lines located in the power chain.

2. The routing arrangement of claim 1, further including a cover for the power chain being provided on the door leaf.

3. The routing arrangement of claim 1, wherein the first end point attached to the door leaf is arranged close to a middle of a width of the door leaf.

4. The routing arrangement of claim 1, wherein the power chain includes two sections which rotate in opposing directions.
